(19) United States
(12) Patent Application Publication
(10) Pub. No.: US 2026/0150007 A1
(43) Pub. Date: May 28, 2026

(54) BANDWIDTH CONTROL DEVICE

(71) Applicant: Fortinet, Inc., Sunnyvale, CA (US)

(72) Inventors: Kento Takeuchi, Kawasaki (JP); Takumi Nakaki, Kawasaki (JP); Takashi Nagumo, Kawasaki (JP); Takeshi Kumagai, Kawasaki (JP)

(73) Assignee: Fortinet, Inc., Sunnyvale, CA (US)

(21) Appl. No.: 18/961,528

(22) Filed: Nov. 27, 2024

(51) Int. Cl. H04W 28/20; H04L 47/6295; H04W 76/11

(52) U.S. Cl. CPC H04W 28/20; H04L 47/6295; H04W 76/11

(57) ABSTRACT

A bandwidth control device is disclosed. The bandwidth control device includes analysis circuitry to determine a user identifier (ID) associated with each of a plurality of data packets and determine a queue number each of the data packets based on the user IDs and bandwidth control circuitry to insert each of the plurality of data packets into one of a plurality of queues based on the queue numbers, generate weight information for each of the plurality of queues based on a weight value associated with each of the plurality of queues and schedule the plurality of packets to be transmitted based on the weight value each of the plurality of queues.

### FIELD

Embodiments discussed generally relate to systems and methods for network bandwidth control.

### BACKGROUND

Mobile networks typically support significant user workloads, which may result in bandwidth issues. Specifically, the Quality of Experience (QoE) often deteriorates when one or more users (heavy users) transfer large workloads, resulting in the entire network bandwidth being squeezed.

Hence, there exists a need to improve bandwidth distribution and latency between network users.

Various embodiments provide a bandwidth control device that includes a plurality of queues to perform weighted fair queueing (WFQ) bandwidth control on received packets and transfer the packets to other communication devices.

This summary provides only a general outline of some embodiments. Many other objects, features, advantages, and other embodiments will become more fully apparent from the following detailed description, the appended claims and the accompanying drawings and figures.

### BRIEF DESCRIPTION OF THE DRAWINGS

A better understanding of the embodiments can be obtained from the following detailed description in conjunction with the following drawings, in which:

FIG. 1A illustrates one embodiment of a network architecture including a bandwidth control device.

FIG. 1B illustrates one embodiment of a system including a bandwidth control device in Embodiment 1.

FIG. 2 illustrates one embodiment of a bandwidth control device.

FIG. 3 illustrates one embodiment of a data structure of an identification user table.

FIG. 4 illustrates one embodiment of processing performed by user identification logic.

FIG. 5 illustrates one embodiment of a data structure of a learning ID pool table.

FIG. 6 is a flow diagram illustrating one embodiment of processing performed by a user learning logic.

FIG. 7 is a flow diagram illustrating one embodiment of processing of a queue distribution logic.

FIG. 8 is a flow diagram illustrating one embodiment of processing performed by an aging logic.

FIG. 9 illustrates one embodiment of a data structure of a weight calculation database.

FIG. 10 illustrates one embodiment of a data structure of a weight calculation user table.

FIG. 11 illustrates one embodiment of a data structure of an accommodated user table.

FIG. 12 illustrates one embodiment of a data structure of an accommodated user table after time elapsed.

FIG. 13 is a flow diagram illustrating one embodiment of processing of a weight calculation database update program.

FIG. 14 is a sequence diagram illustrating one embodiment of processing of an analysis logic and a bandwidth control logic.

FIG. 15 illustrates one embodiment of WFQ logic.

FIG. 16 illustrates another embodiment of a system including a bandwidth control device and a controller.

FIG. 17 illustrates one embodiment of a configuration of the bandwidth control device.

FIG. 18 is a flow diagram illustrating one embodiment of a process performed by a controller communication program.

FIG. 19 is a flow diagram illustrating one embodiment of a process for calculating weights.

FIG. 20 is a sequence diagram illustrating one embodiment of a processing sequence between a bandwidth control device and a controller.

### DETAILED DESCRIPTION

According to one embodiment, a bandwidth control device including a plurality of queues to perform bandwidth control is provided. Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs. PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “logic,” “engine,” “component,” “module,” “system,” and the like as used herein are intended to refer to a computer-related entity, either software-executing general-purpose processor, hardware, firmware and a combination thereof. For example, a component may be, but is not limited to being, a process running on a processor, a processor, an object, an executable, a thread of execution, a program, and/or a computer.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform the one or more network functions. Other network devices may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance” or a network security device” that may reside within the particular network that it is protecting, or network security may be provided as a service with the network security device residing in the cloud. For example, while there are differences among network security device vendors, network security devices may be classified in three general performance categories, including entry-level, mid-range, and high-end network security devices. Each category may use different types and forms of central processing logics (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support. Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways. UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances). DoS attack detection appliances (e.g., the FORTIDDOS family of DoS attack detection and mitigation appliances) and endpoint protection, detection and response appliances (e.g., FORTIEDR family of security appliances).

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views of processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

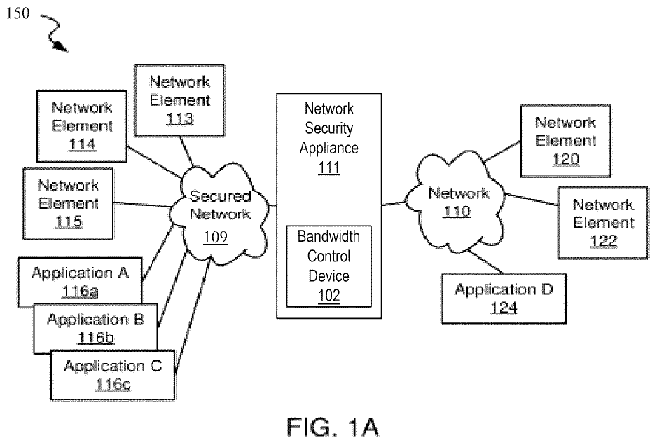

Turning to FIG. 1A, network architecture 150 is shown in accordance with some embodiments. In the context of network architecture 150, a network security appliance 111 controls access to network elements within a secured network 109. Secured network 109 may be any type of communication network known in the art. Those skilled in the art will appreciate that, secured network 109 can be a wireless network, a wired network, or a combination thereof that can be implemented as one of the various types of networks, such as an Intranet, a Local Area Network (LAN), a Wide Area Network (WAN), an Internet. and the like. Further, secured network 109 can either be a dedicated network or a shared network. The shared network represents an association of the different types of networks that use a variety of protocols, for example. Hypertext Transfer Protocol (HTTP), Transmission Control Protocol/Internet Protocol (TCP/IP). Wireless Application Protocol (WAP), and the like.

Secured network 109 provides for internetwork communications between network elements 113, 114, 115 and applications 116 (e.g., application A 116 a, application B 116 b, and application C 116 c). Network security appliance 111 operates as a gateway between secured network 109 and outside networks (e.g., a network 110). Network 110 may be any type of network known in the art.

Thus, network 110 may be, but is not limited to, a wireless network, a wired network or a combination thereof that can be implemented as one of the various types of networks, such as the Internet, an Intranet, a Local Area Network (LAN), a Wide Area Network (WAN), and the like. Network security appliance 11I provides for communications between network element 113 and network element 120, network element 122, and network element 124 via network 110.

Network security appliance 111 includes bandwidth control device 102 that is implemented to perform bandwidth control of network packet traffic within network architecture 150. FIG. 1B illustrates another embodiment of a network architecture 150 including bandwidth control device 102. In this embodiment, network architecture 150 includes a plurality of servers 100, a network A 101, bandwidth control device 102, a network B 103, and a plurality of clients 104. The plurality of servers 100 includes, for example, a server that stores and provides data to the clients 104. The network A 101 may comprise a network connecting the plurality of servers 100 and the bandwidth control device 102, while network B 103 may comprise a network coupling bandwidth control device 102 and the plurality of clients 104. In embodiments, the plurality of clients 104 comprise client computing devices implemented by a user to transfer (e.g., transmit and receive) data with the plurality of servers 100.

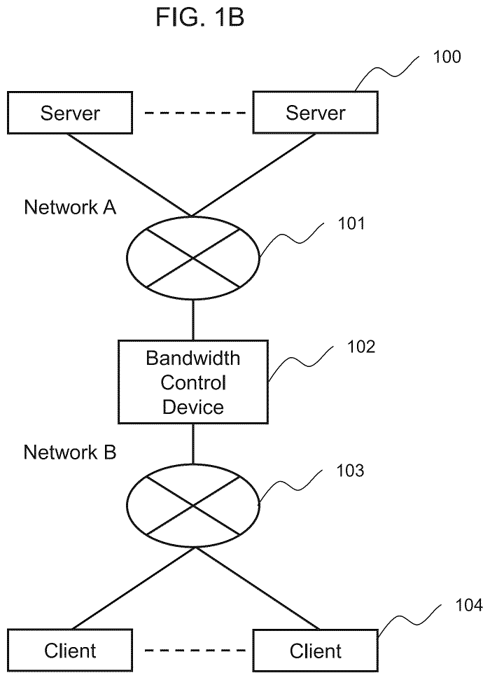

According to one embodiment, bandwidth control device 102 prevents one or more of clients 104 from over-utilization of the bandwidth of the networks A 101 and B 103, which would result in the deterioration of QoE of the other clients 104. In further embodiments, the devices in network architecture 150 may be either wired or wireless. FIG. 2 illustrates one embodiment of a bandwidth control device. As shown in FIG. 2, bandwidth control device 102 includes receiving logic 200 analysis logic 201, bandwidth control logic 202, transmission logic 206, a memory 203 for analysis logic 201, a CPU (Central Processing Logic) 205, and a memory 204 for CPU 205. In one embodiment, memory 203 includes a user table 214 and a learning ID (Identification) pool table 215, while memory 204 includes a weight calculation database 216 and a weight calculation database update program 217.

The receiving logic 200 comprises an interface for receiving packets from the network A 101, which are transmitted from the transmission logic 206 to the network B 103 via analysis logic 201 and bandwidth control logic 202. In one embodiment, analysis logic 201 includes user identification logic 207, client learning logic 208, queue distribution logic 209 and aging logic 210. Analysis logic 201 receives packets from receiving logic 200. Subsequently, user identification logic 207 within analysis logic 201 identifies a client 104 associated with a packet destination for each received packet.

Client learning logic 208 stores the identity of each client 104 from which packet data has recently been received. Queue distribution logic 209 then determines a packet transfer destination queue associated with a client 104. In such an embodiment, bandwidth control logic 202 includes a queue 211 (e.g., 211₀-211ₙ) associated with each client 104. In one embodiment, analysis logic 201 also includes aging logic to perform an aging process to delete the identity of each client stored in identification logic 207 for which a packet has not been received for a predetermined time period.

According to one embodiment, analysis logic 201 is coupled to memory 203 and CPU 205. Further, analysis logic 201 searches and updates the contents of a user table 214 and the learning ID (Identification) pool table 215 in memory 203. In addition, when the analysis logic 201 updates the user table 214, analysis logic 201 transmits the update information to the CPU 205. The functions and detailed processing of each part in the analysis logic 201 will be described in more detail below. In a further embodiment, user table 214 is used by user identification logic 207, aging logic 210, and client learning logic 208, and includes destination information for identifying the source user of the packet received by receiving logic 200.

Bandwidth control logic 202 transmits packets received from analysis logic 201 to transmission logic 206 while performing fair control for each user. The bandwidth control logic 202 includes a queue 211 that stores received packets with n queues (queue 211-0 to queue 211-n), a weighted fair queueing (WFQ) logic 212 that outputs packets stored in the queue 211 according to the weight set for each queue, and bandwidth shaping logic 213 that controls the transmission bandwidth. Packets received from the analysis logic 201 are transferred to the transmission logic 206 via queue 211, WFQ logic 212, and bandwidth shaping logic 213. In embodiments, bandwidth shaping logic 213 is set with a maximum bandwidth that can be transmitted.

According to one embodiment, WFQ logic 212 is set with weights W₀˜Wₙ for each queue 211. The weights for each of these queues may be set by the weight calculation database update program 217 that the CPU 205 executes based on the weight calculation database 216 in the CPU memory 204. The analysis logic 201 and the bandwidth control logic 202 are configured by, for example, a logic circuit such as an ASIC (Application Specific Integrated Circuit) or an FPGA (Field Programmable Gate Array), or a network processor, but are not limited thereto. The analysis logic 201 and the bandwidth control logic 202 may be configured by, for example, a logic circuit such as an ASIC (Application Specific Integrated Circuit) or an FPGA (Field Programmable Gate Array), or a network processor, but are not limited thereto.

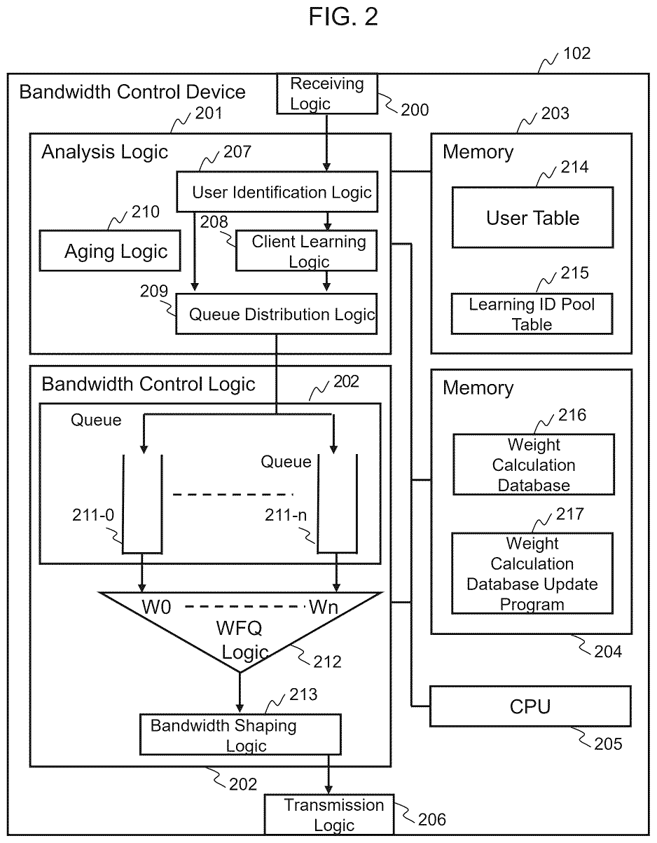

FIG. 3 illustrates one embodiment of a data structure of a user table 214. User table 214 includes a plurality of entries, each of which includes a user identifier 300, a learning ID 301, and a validity period 302. The user identifier 300 is a field for storing identification information for uniquely identifying the client 104 that transmitted the packet received by the user identification logic 207. In this embodiment, a destination IP address of the received packet is stored as a user identifier in order to perform fair control on packets destined from a server 100 to a client 104 (also referred to as a client user or user). The learning ID 301 comprises a field that stores a value uniquely associated with each user identifier 300. The validity period 302 is a field that stores the validity period of the entry.

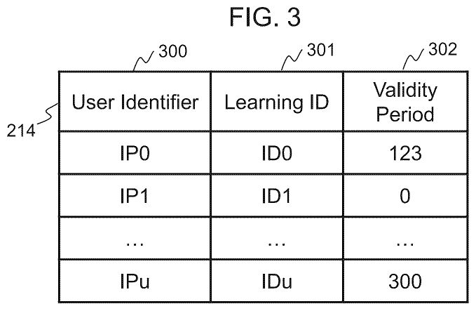

FIG. 4 illustrates one embodiment of processing performed by user identification logic 207. User identification logic 207 receives a packet from the receiving logic 200 (processing block S401) and extracts the destination IP address as a user identifier from the received packet (processing block S402). At processing block S403, user identification logic 207 searches the user table 214 for an entry in which the extracted user identifier is included in the user identifier 300. Upon a determination that the entry is not found, the client 104 is determined to be an unlearned user (processing block S404) and the user identification logic 207 transfers the received packet to the client learning logic 208 (processing block S405). Upon a determination that that the client 104 is not an unlearned user, user identification logic 207 sets the validity period 302 of the entry in the user table 214 (e.g., to 300 seconds) (processing block S406) and transfers the received packet and the value of the learning ID 301 of the found entry to queue distribution logic 209 (processing block S407).

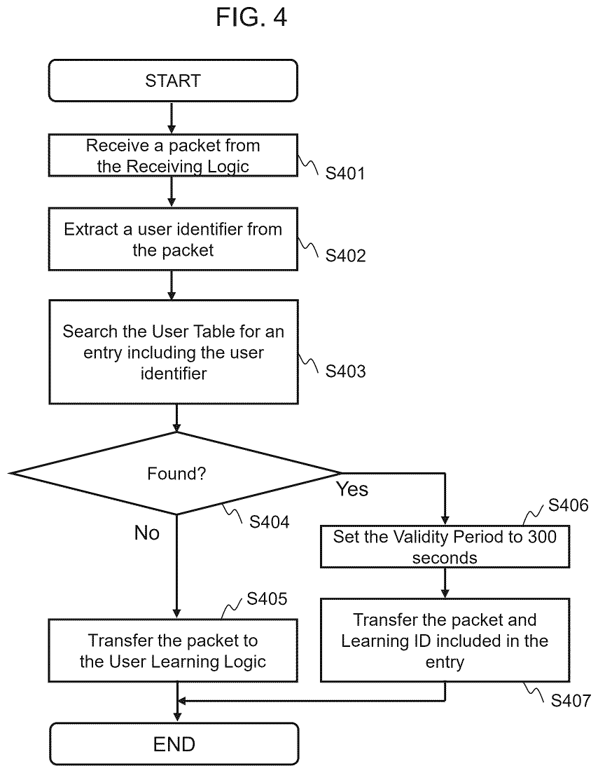

In one embodiment, a learning ID pool table 215 includes a plurality of entries, each of which includes a learning ID 500. In a further embodiment, the learning ID 500 is a field for pooling learning IDs to be assigned to newly learned user by the client learning logic 208. FIG. 5 illustrates one embodiment of a data structure of a learning ID pool table.

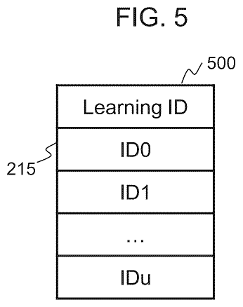

Upon receiving a packet having a user identifier not registered in the user table 214, client learning logic 208 registers the user identifier and the learning ID in a user table 214. FIG. 6 is a flow diagram illustrating one embodiment of processing performed by a client learning logic 208 using learning ID pool table 215. The client learning logic 208 receives a packet from the user identification logic 207 (processing block S601) and extracts the destination IP address as a user identifier from the received packet (processing block S602). At processing block S603, client learning logic 208 acquires the value of the learning ID 500 from one entry of the learning ID pool table 215 and deletes the entry from the learning ID pool table 215.

At processing block S604, client learning logic 208 adds a new entry in the user table 214, and registers the extracted user identifier, the learning ID acquired, and the validity period in the entry (e.g., 300 seconds). At processing block S605, CPU 205 is notified of the user identifier and learning ID registered by S604 as learning information (S605). The 300 seconds of the validity period is an example and is not limited thereto. At processing block S606, client learning logic 208 transfers the received packet and the registered learning ID to queue distribution logic 209.

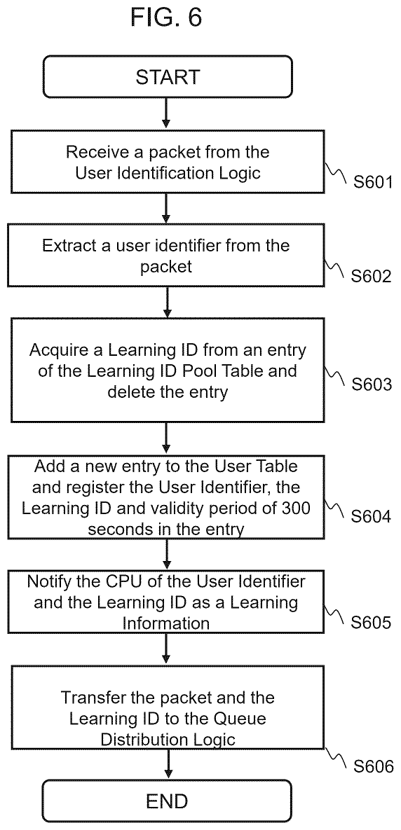

FIG. 7 is a flow diagram illustrating one embodiment of processing of a queue distribution logic. At processing block S701, queue distribution logic 209 receives the packet and the learning ID from user identification logic 207 or the client learning logic 208. At processing block S702, queue distribution logic 209 calculates the destination queue number. In one embodiment, queue distribution logic 209 calculates a destination queue number based on calculation received from the learning IDs received from user identification logic 207 or client learning logic 208. In one embodiment, the calculation is represented as:

destination queue number=learning ID mod n,

where, n is the number of queues held by the queue 211, and mod is an operator for obtaining the remainder when the left term is divided by the right term. At processing block S703, queue distribution logic 209 transfers the received packet to any one of the queues 211₀˜211ₙ corresponding to the calculated destination queue number based on the calculation result of S702.

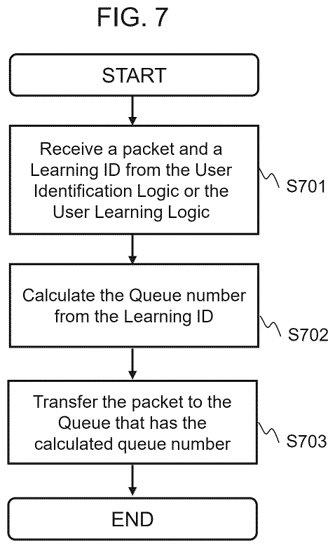

FIG. 8 is a flow diagram illustrating one embodiment of processing performed by an aging logic 210. In one embodiment, aging logic 210 begins operation at the time bandwidth control device 102 is activated (e.g., processing block S800). At processing block S801, the aging logic 210 subtracts the validity period 302 in the entry of the user table 214 by a predetermined waiting time, described below. At processing block S802, aging logic 210 confirms the validity period 302. At processing block S803, aging logic 210 determines whether the validity period 302 is less than or equal to zero (e.g., packet traffic associated with the user ID has not been received within the validity period). Aging logic 210 deletes the entry upon a determination that the validity period is less than zero, creates a new entry in the learning ID pool table 215 and registers the learning ID contained in the deleted entry of the user table 214, processing block S804. At processing block S805, CPU 205 is notified of the user identifier and learning ID included in the entry deleted as an aging timeout information.

After processing block S805, or upon a determination at processing block S803 that the effective time is not less than 0, the process waits for a predetermined period of time to elapse, processing block S806. Subsequently, control is returned to processing block S801. In one embodiment, processing blocks S801 to S803 are executed for all entries in the user table 214. In a further embodiment, processing blocks S800 to S806 comprise loop processing for performing aging timeouts of user information registered in the user table 214. Information of a client 104 for which packets have not received for a certain period can be deleted from the user table 214 and the deleted information can be notified to CPU 205.

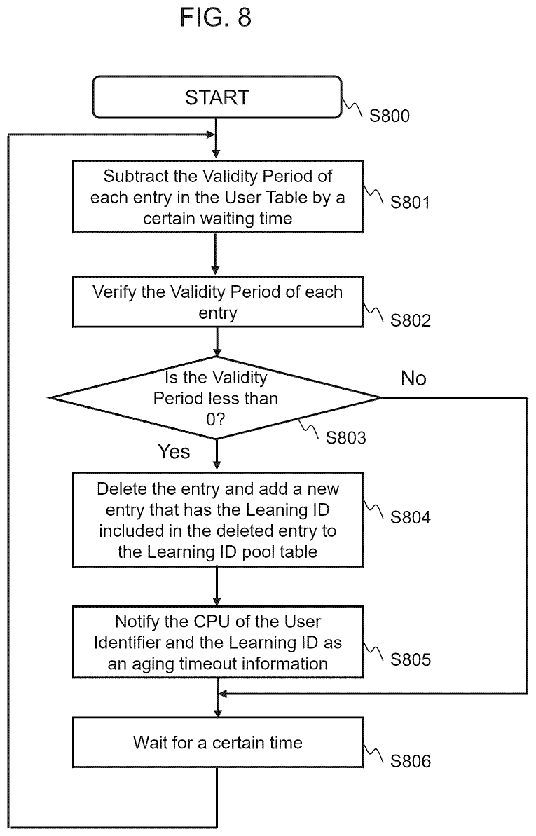

As discussed above, bandwidth control logic 202 uses weight information calculated by the CPU 205. FIG. 9 illustrates one embodiment of a data structure of a weight calculation database. The weight calculation database 216 includes a weight calculation user table 900 and an accommodated user table 901. The weight calculation user table 900 stores information for generating the accommodated user table 901. The accommodated user table 901 stores information for setting the weight for each queue in the queue 211 to the WFQ logic 212.

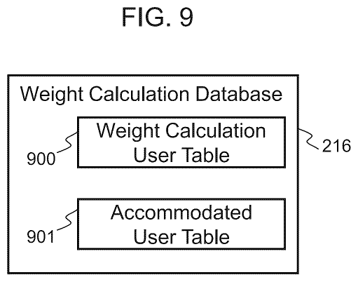

FIG. 10 illustrates one embodiment of a data structure of a weight calculation user table 900. The weight calculation user table 900 includes a plurality of entries, comprising of a user identifier 1000, a learning ID 1001, and a destination queue number 1002. In one embodiment, user identifier 1000 and the learning ID 1001 are fields for storing the same information as the user identifier 300 and the learning ID 301 of the user table 214. The destination queue number 1002 is a field that stores the same information as the destination queue number calculated by the queue distribution logic 209.

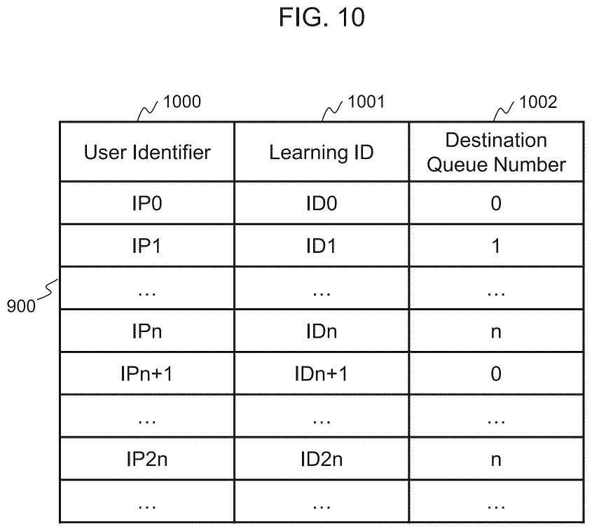

FIG. 11 illustrates one embodiment of a data structure of an accommodated user table 901. As shown in FIG. 11, accommodated user table 901 includes a plurality of entries, each comprising of a queue number 1100, a number of accommodated users 1101, and a weight 1102. In one embodiment, queue number 1100 comprises a field that stores the queue number corresponding to the queue 211₀˜queue 211ₙ, while accommodated user number 1101 comprises a field that stores the number of users accommodated in each queue indicated by the queue number 1100. The weight 1102 comprises a field for storing weights set in the WFQ logic 212 calculated from the accommodated user number 1101.

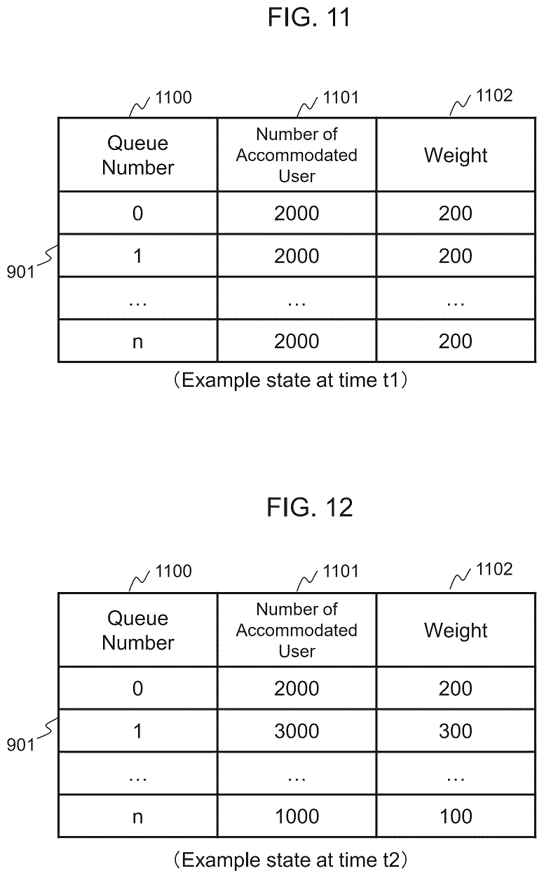

FIG. 12 illustrates one embodiment of a data structure of an accommodated user table 901 after a time t2 has been reached, assuming that the contents of the accommodation user table 901 at time t1 (t1<t2) are in the state shown in FIG. 11. Compared with the time t1, the number of accommodated users of the queue 211₁ having the queue number 1 has increased from 2000 to 3000, and the number of accommodated users of the queue 211ₙ having the queue number n has decreased from 2000 to 1000.

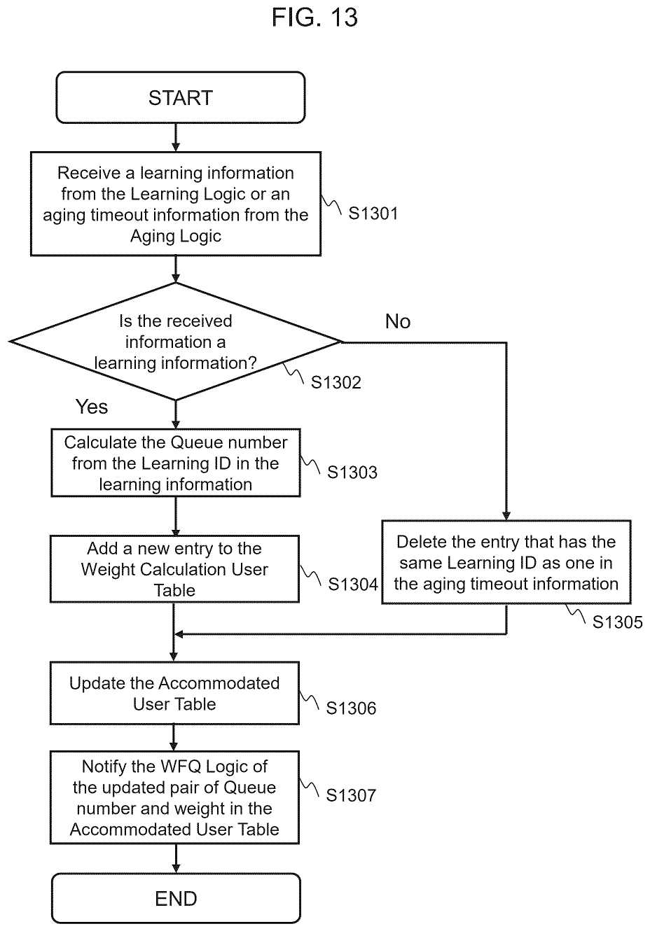

FIG. 13 is a flow diagram illustrating one embodiment of processing of a weight calculation database update program 217 In one embodiment, weight calculation database update program 217 is executed by the CPU 205. At processing block S1301, weight calculation database update program 217 receives the learning information or the aging timeout information related to the user table 214 from client learning logic 208 or the aging logic 210. At decision block S1302, a determination is made as to whether the received information is the learning information. If so, weight calculation database update program 217 uses the learning ID included in the received learning information to calculate the queue number (e.g., using the same calculation process as the processing of queue distribution logic 209 at processing block S702 in FIG. 7), processing block S1303. At processing block S1304, the user identifier and the learning ID included in the received learning information and the calculated queue number are registered in a new entry of the weight calculation user table 900.

Upon a determination at decision block S1302 that the received information is not learning information (e.g., when it is aging timeout information), weight calculation database update 217 searches from the weight calculation user table 900 for an entry comprising the user identifier 1000 included in the aging timeout information, and deletes the entry, processing block S1305. At processing block S1306, weight calculation database update program 217 updates the accommodated user table 901.

In one embodiment, updating the accommodated user table 901 of S1306 is implemented using the embodiment of FIG. 12. In this embodiment, the weight set on the queue is based on 200 when the number of users accommodated in the queue is 2000, and the ratio of the number of accommodated users in each queue and the weight ratio are equal. In the state of FIG. 12, the weight 1102 is set to “200” since the accommodated user number 1101 of queue number 0 is 2000. Further, since the ratio of the accommodated user number 1101 of the queue number 0 and the queue number 1 is 2:3, the weight 1102 of the queue number 1 is set to “300” so that the ratio is 2:3. Similarly, since the ratio of the accommodated user number 1101 of the queue number 0 and the queue number n is 2:1, the weight 1102 of the queue number n is set to “100” so that the ratio of the queue number 0 and the weight 1102 of the queue number n is 2:1. When the weights 1102 of all entries are calculated, the combination of the values of the queue number 1100 and the weight 1102 stored in the updated entry of the accommodated user table 901 is notified to the WFQ logic 212, processing block S1307.

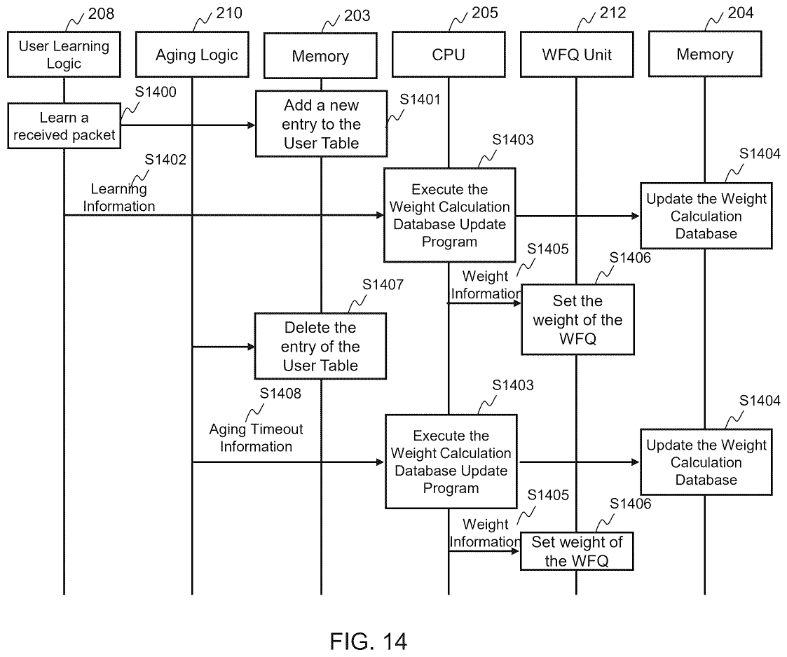

FIG. 14 is a sequence diagram illustrating one embodiment of the relationship between the operation of each part from learning the user to the aging timeout between analysis logic 201, bandwidth control logic 202, and CPU 205. At S1400, client learning logic 208 learns the destination user of the packet received from the user identification logic 207 (e.g., according to the flow diagram shown in FIG. 6). At S1401 client learning logic 208 adds a new entry in the user table 214 in memory 203. In addition, client learning logic 208 notifies the CPU 205 of the learning information, S1402, and the CPU 205 executes the weight calculation database update program 217 (e.g., according to the flow diagram shown in FIG. 13) (S1403).

Weight calculation database update program 217 updates the weight calculation database 216 (S1404) and notifies the WFQ logic 212 of the combination of the queue number and the weight value updated in S1404 as a weight information (S1405). The WFQ logic 212 that has received the weight information from the CPU 205 sets the weight of the WFQ according to the received queue number and weight value included in the weight information (S1406). The aging logic 210 deletes the entry of the client 104 whose packet was not received for the predetermined time in the user table 214 (S1407) (e.g., according to the process flow described in FIG. 8).

The CPU 205 that has received the aging timeout information S1408 from the aging logic 210 executes the weight calculation database update program 217 (e.g., according to the flow diagram shown in FIG. 13). The weight calculation database update 217 updates the weight calculation database 216 (S1404) and notifies the WFQ logic 212 of the combination of the queue number and the weight value updated in S1404 as a weight information (S1405). The WFQ logic 212 that has received the weight information from the CPU 205 sets the weight of the WFQ according to the received queue number and weight value in the weight information (S1406).

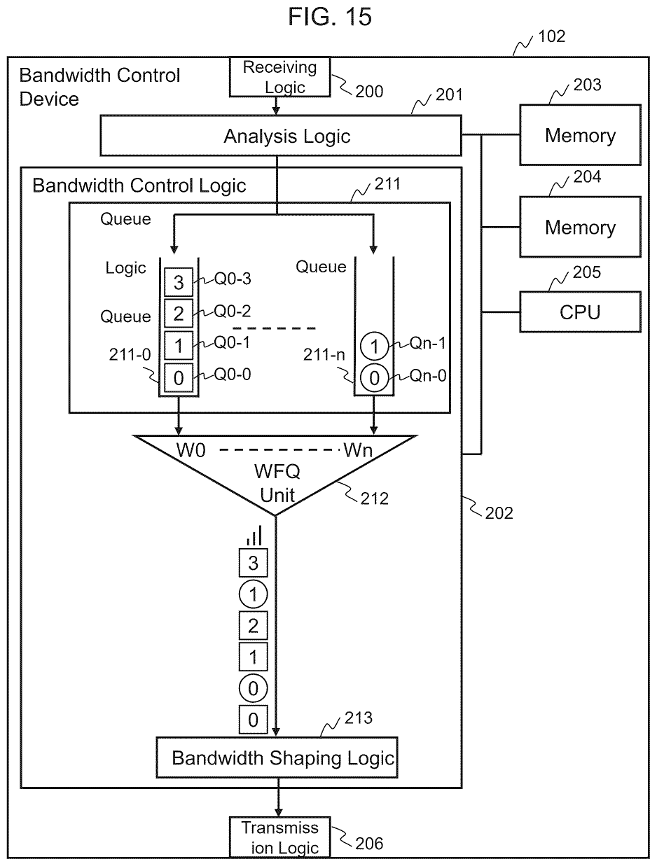

FIG. 15 illustrates one embodiment of WFQ logic 212. In one embodiment, WFQ is an algorithm that schedules packets to be transmitted from multiple queues by the weight set for each queue. In this embodiment, the ratio of output bandwidth of each queue is guaranteed according to the weight set in WFQ, rather than being output in the order of queued “first come-first-served”. When the weight of the iₜₕ queue 211ᵢ is Wᵢ, the guaranteed bandwidth of the iₜₕ queue is determined by:

$$Guaranteed bandwidth = {W}_{i} / ( Sum of weights of each queu ) * Max bandwidth of bandwidth shaping logic 213$$

Upon a determination that weights W₀˜Wₙ of each queue are all equal, the guaranteed bandwidth per queue is expressed by:

$$Guaranteed bandwidth = 1 / n * Max bandwidth of bandwidth shaping logic 213$$

According to one embodiment, the weight of WFQ logic 212 is set according to the weight 1102 of the accommodated user table 901 by the operation of the CPU 205. FIG. 15 shows the state when the contained user table 901 is in the state of FIG. 12. That is, the weights W₀ and Wₙ of WFQ logic 212 are W0=200 and Wₙ=100, respectively. Further, packets stored in the queue 211₀ are represented as Q0₀˜Q0₃, and packets stored in the queue 211ₙ are expressed as Qn₀˜Qn₁. WFQ logic 212 performs scheduling according to the weight and outputs packets from the queue 211₀˜queue 211₀. Specifically, in the state of FIG. 15, the weights of W₀ and Wₙ of WFQ logic 212 are also 2:1 since the ratio of the number of accommodated users of the queue 211₀ and the queue 211ₙ is 2:1.

As described above, the number of users accommodated for each queue is uniform by using a learning ID uniquely assigned to each user. Even if the user is ageing time out and the number of users accommodated in each queue is biased, the weight of the WFQ logic 212 is adjusted by the weight calculation database update 217 to fairly control the client 104 transmission opportunity.

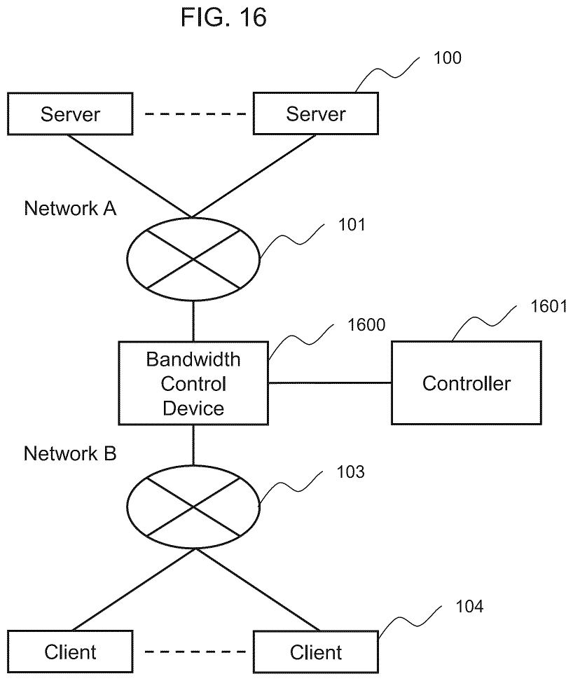

FIG. 16 illustrates another embodiment of network architecture 150. In this embodiment, a controller 1601 is added to servers 100, a network A 101, a bandwidth control device 1600, network B 103 and clients 104. In the embodiment disclosed with reference to FIG. 1B, the weight set in WFQ was calculated by CPU 205 and memory 204 in bandwidth control device 102. However, depending on bandwidth control device 102 may be difficult to calculate the weight set in WFQ due to low CPU performance or low memory capacity. In this embodiment, controller 1601 comprises a CPU and memory that calculates the weight set to WFQ to the system.

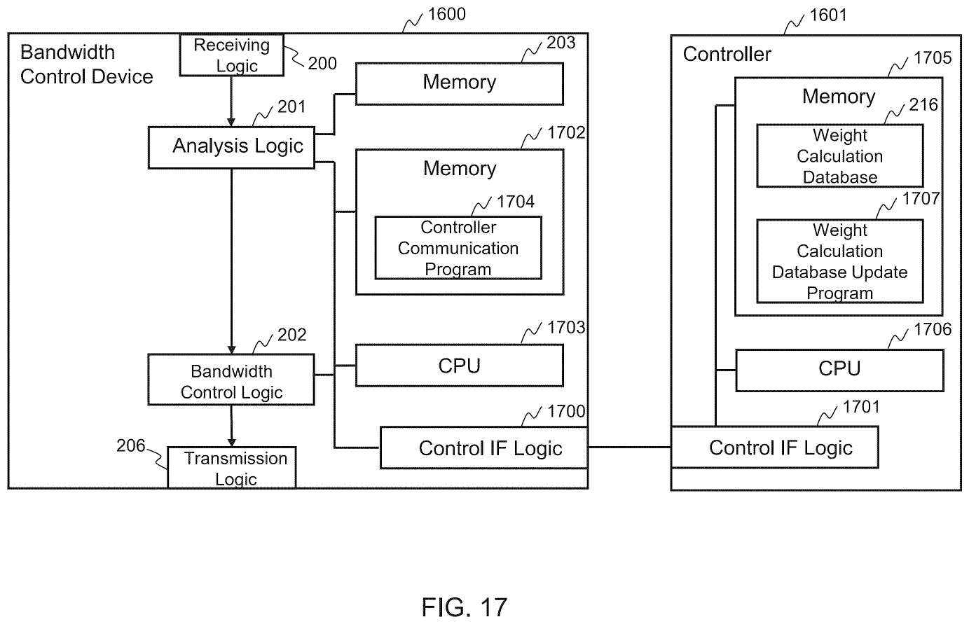

FIG. 17 illustrates one embodiment of a configuration of bandwidth control device 1600 and controller 1601. In this embodiment, bandwidth control device 1600 includes receiving logic 200, an analysis logic 201, a bandwidth control logic 202, a transmission logic 206, a memory 203 used by the analysis logic 201, CPU 1703, a memory 1702 used by a CPU 1703, and a control IF (Interface) logic 1700. Memory 1702 stores a controller communication program 1704 that controls communication between the bandwidth control device 1600 and the controller 1601. In this embodiment, identical components included in the previous embodiment are denoted by the same numerals as those shown in FIG. 2.

In one embodiment, controller 1601 comprises a device including memory 1705, CPU 1706, and a control interface (IF) logic 1701. Memory 1705 stores a weight calculation database 216 and a weight calculation database update program 1707. In this embodiment, memory 1702 and CPU 1703 of the bandwidth control device 1600 may be components with a lower capacity and lower performance than the memory 204 and CPU 205 shown in FIG. 2. Further, bandwidth control device 1600 and controller 1601 are coupled (e.g., wired or wireless) via control IF logic 1700 and 1701, respectively.

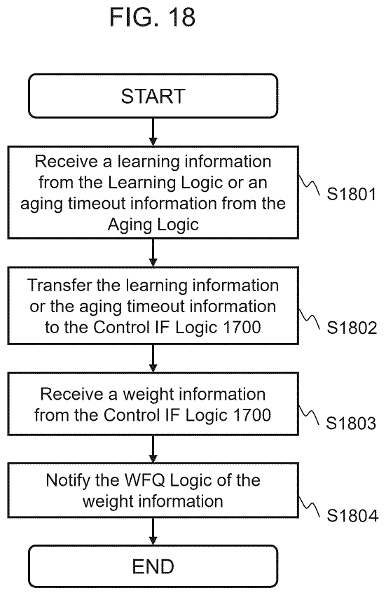

FIG. 18 is a flow diagram illustrating one embodiment of a process performed by a controller communication program 1704. At processing block S1801, controller communication program 1704 receives learning information from the client learning logic 208 included in the analysis logic 201 or aging timeout information from the aging unit 210 at CPU 1703. At processing block S1802, controller communication program 1704 transmits the learning information or the received aging timeout information to the control IF logic 1700. In this embodiment, the learning information or the aging timeout information transferred by control IF logic 1700 to the control IF unit 1701 of the controller 1601.

Controller communication program 1704 then receives weight information from the control IF logic 1700 (processing block S1803) and notifies the WFQ logic 212 of the weight information received by S1803 (processing block S1804). In this embodiment, the weight information received from the control IF logic 1700 is received from the controller 1601 by the control IF logic 1700, as will be discussed in more detail below. In a further embodiment, a header may be added to encapsulate and transmit the learning information and the aging timeout information when transmitting the learning information or the aging timeout information to the control IF logic 1700 in S1802. Additionally, the weight information may be notified to the WFQ logic 212 after the header is removed and decapsulated whenever a header is added to the weight information received in S1803.

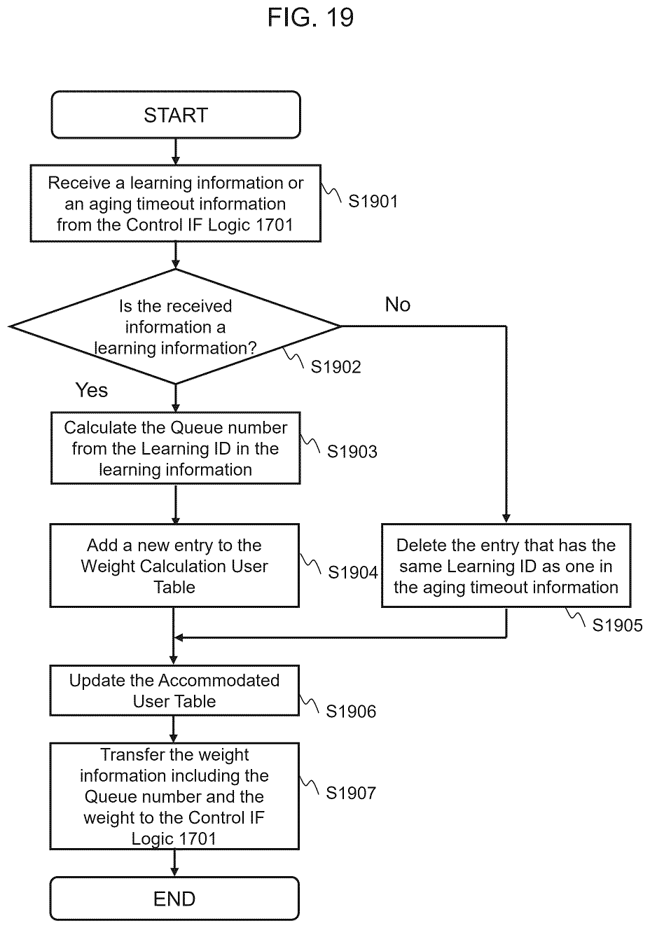

FIG. 19 is a flow diagram illustrating one embodiment of a process for calculating weights. At processing block S1901, the weight calculation database update program 1707 receives learning information or aging timeout information from the bandwidth control device 1600 via the control IF logic 1700 and 1701. At decision block S1902, a determination is made as to whether the received information is learning information. Upon a determination that the received information is the learning information, the weight calculation database update program 1707 uses the learning ID to calculate the queue number by the same calculation method as the processing of the queue distribution logic 209, processing block S1903 (e.g., processing block S702 in FIG. 7). At processing block S1904, a new entry is created in the weight calculation user table 900 in the weight calculation database 216, and the user identifier and received learning ID and the calculated queue number are registered in the entry.

Upon a determination that the received information is not the learning information (e.g., when it is the aging time information), the weight calculation database update program 1707 searches from the weight calculation user table 900 for an entry that includes a user identifier included in the received aging timeout information in the user identifier 1000 and deletes the entry, processing block S1905. At processing block S1906, the weight calculation database update program 1707 updates the accommodated user table 901. At processing block S1907, the combination of values of queue number 1100 and weight 1102 stored in the entry of the updated accommodated user table 901 is forwarded to control IF unit 1701.

In one embodiment, the information notified here is transmitted from the control IF unit 1701 to the control IF logic 1700. Again, a header may be added to encapsulate and transmit the learning information and the aging timeout information to the control IF logic 1700, and later removed and decapsulated. Further, when notifying the weight information to the control IF unit 1701, a header may be added to encapsulate and notify the weight information.

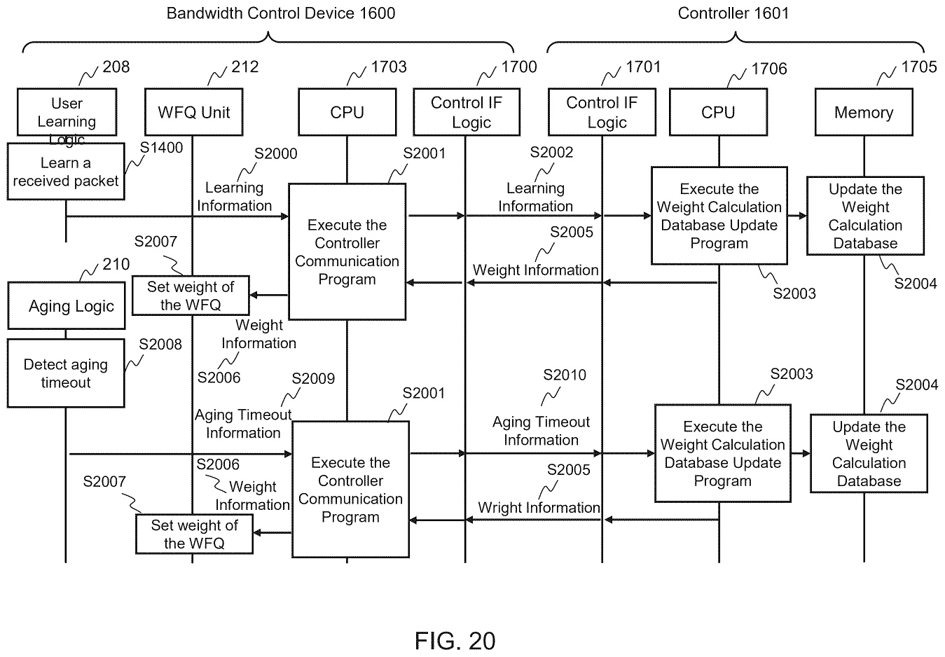

FIG. 20 is a sequence diagram illustrating one embodiment of a processing sequence between a bandwidth control device and a controller. The client learning logic 208 included in the analysis logic 201 of the bandwidth control device 1600 learns the destination user of the packet received by the receiving unit 200 (S1400) and transfers the learning information to the CPU 1703 of the bandwidth control device 1600 (S2000). CPU 1703 executes the controller communication program 1704 (S2001) and transfers the learning information received by the S2000 to the CPU 1706 of the controller 1601 via the control IF logic 1700 and 1701 (S2002).

CPU 1706 executes the weight calculation database update program 1707 (S2003) and updates the weight calculation database 216 by processing the flow diagram shown in FIG. 19 based on the learning information received in S2002 (S2004). The weight calculation database update program 1707 transfers the weight information updated in S2004 to the CPU 1703 via control IF logic 1701 and 1700 (S2005).

Controller communication program 1704 executed by the CPU 1703 transfers the weight information received in S2005 to the WFQ logic 212 in the bandwidth control logic 202 (S2006). The WFQ logic 212 that has received the weight information sets the weight of the WFQ according to the received weight information (S2007). Whenever the aging logic 210 in the analysis logic 201 detects an aging timeout (S2008) in the process flow described in FIG. 8, the aging timeout information is transferred to the CPU 1703 of the bandwidth control device 1600 (S2009). CPU 1703 executes the controller communication program 1704 (S2001) and transfers the aging timeout information received in S2009 to CPU 1706 of the controller 1601 via control IF logic 1700 and 1701 (S2010).

CPU 1706 executes the weight calculation database update program 1707 (S2003) and updates the weight calculation database 216 by processing the flow diagram shown in FIG. 19. Then, the weight calculation database update program 1707 notifies the CPU 1703 of the weight information updated in S2004 via the control IF logic 1701 and 1700 (S2005). Controller communication program 1704 executed in S2001 in CPU 1703 transfers the weight information received from S2005 to the WFQ unit (S2006). The WFQ unit that received the weight information sets the weight of the WFQ according to the received weight information (S2007).

By providing a controller coupled to the bandwidth control device and configuring the controller to calculate the weight of WFQ necessary for bandwidth control, even in a system using a bandwidth control device equipped with a low capacity memory and a low-performance CPU.

Thus, it will be appreciated by those of ordinary skill in the art that the diagrams, schematics, illustrations, and the like represent conceptual views or processes illustrating systems and methods. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing described embodiments. Those of ordinary skill in the art further understand that the exemplary hardware, software, processes, methods, and/or operating systems described herein are for illustrative purposes and, thus, are not intended to be limited to any particular named.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments, other and further embodiments may be devised without departing from the basic scope thereof. The scope of the embodiments is determined by the claims that follow. The embodiments are not limited to the described embodiments, versions or examples, which are included to enable a person having ordinary skill in the art to make and use the embodiments when combined with information and knowledge available to the person having ordinary skill in the art.

What is claimed is:

1. A bandwidth control device comprising:
analysis circuitry to determine a user identifier (ID) associated with each of a plurality of data packets and determine a queue number associated with each of the data packets based on the user IDs; and
bandwidth control circuitry to insert each of the plurality of data packets into one of a plurality of queues based on the queue numbers and schedule the plurality of packets to be transmitted based on a weight value associated with each of the plurality of queues.

2. The device of claim 1, wherein the bandwidth control circuitry further to receive weight information for each of the plurality of queues.

3. The device of claim 1, further comprising bandwidth shaping circuitry to control a transmission bandwidth of the scheduled packets to be transmitted.

4. The device of claim 3, wherein each of the plurality of queues is guaranteed an output bandwidth corresponding to the associated weight value.

5. The device of claim 4, wherein the guaranteed output bandwidth for a queue is determined based on the weight value of the queue, a sum of the weights associated with the plurality of queues and a maximum bandwidth of the bandwidth shaping circuitry.

6. The device of claim 2, further comprising:
one or more memory devices to store a plurality of tables; and
one or more processing resources to generate the weight information based on information in at least one of the plurality of tables.

7. The device of claim 6, wherein the weight information is generated based on a quantity of users accommodated in each of the plurality of queues.

8. The device of claim 1, wherein the analysis circuitry determines whether a user table includes a user ID associated with a received packet and setting a validity period to a predetermined time upon determining the user table includes the user ID.

9. The device of claim 8, wherein the analysis circuitry further adds a new entry in the table user ID associated with the received packet upon determining the user table does not include the user ID.

10. The device of claim 8, wherein the analysis circuitry further deletes the user ID from the user table upon determining that a second packet associated with the user ID has not been received within the validity period.

11. A method comprising:
determining a user identifier (ID) associated with each of a plurality of data packets;
determining a queue number associated with each of the data packets based on the user IDs;
inserting each of the plurality of data packets into one of a plurality of queues based on the queue numbers; and
scheduling the plurality of packets to be transmitted based on a weight value associated with each of the plurality of queues.

12. The method of claim 11, further comprising generating weight information for each of the plurality of queues based on the weight values, wherein each of the plurality of queues is guaranteed an output bandwidth corresponding to the associated weight value.

13. The method of claim 12, further comprising controlling a transmission bandwidth of the scheduled packets to be transmitted.

14. The method of claim 12, further wherein the guaranteed output bandwidth for a queue is determined based on the weight value of the queue, a sum of the weights associated with the plurality of queues and a maximum bandwidth.

15. The method of claim 11, further comprising:
determining whether a user table includes a user ID associated with a received packet;
setting a validity period to a predetermined time upon determining the user table includes the user ID; and
adding a new entry in the table user ID associated with the received packet upon determining the user table does not include the user ID.

16. At system comprising:
a controller including:
one or more memory devices to store a plurality of tables; and
one or more processing resources to generate weight values based on information in at least one of the plurality of tables; and
a bandwidth control device, coupled to the controller, to determine a user identifier (ID) associated with each of a plurality of data packets and determine a queue number associated with each of the data packets based on the user IDs, insert each of the plurality of data packets into one of a plurality of queues based on the queue numbers and schedule the plurality of packets to be transmitted based on a weight value associated with each of the plurality of queues.

17. The system of claim 16, wherein the bandwidth control device further to control a transmission bandwidth of the scheduled packets to be transmitted.

18. The system of claim 17, wherein each of the plurality of queues is guaranteed an output bandwidth corresponding to the associated weight value.

19. The system of claim 16, wherein the bandwidth control device further to determine whether a user table includes a user ID associated with a received packet and setting a validity period to a predetermined time upon determining the user table includes the user ID and add a new entry in the table user ID associated with the received packet upon determining the user table does not include the user ID.

20. The system of claim 19, wherein the bandwidth control device further to delete the user ID from the user table upon determining that a second packet associated with the user ID has not been received within the validity period.
